(19) United States
(12) Patent Application Publication
(10) Pub. No.: US 2003/0179078 A1
(43) Pub. Date: Sep. 25, 2003

(54) Radio frequency tag circuit and method for reading multiple tags

(75) Inventors: Eric Chen, Hsinchu (TW); Min-Kun Wang, Hsinchu (TW); Chieh-Yung Tu, Hsinchu (TW); Chien-Hsien Tsai, Hsinchu (TW); Shih-Ting Chang, Hsinchu (TW)

Correspondence Address: Webb Ziesenheim, Logsdon Orkin & Hanson, P.C., 700 Koppers Building, 436 Seventh Avenue, Pittsburgh, PA, 15219-1818, US

(73) Assignee: HOLTEK SEMICONDUCTOR INC.

(21) Appl. No.: 10/231,710

(22) Filed: Aug. 30, 2002

(30) Foreign Application Priority Data
Mar. 25, 2002 (TW) 91105799

(51) Int. Cl. H04Q 5/22

(52) U.S. Cl. 340/10.2; 340/10.4; 340/572.1

(57) ABSTRACT

An identification data transmitting circuit for controlling a transmission of an identification data in radio frequency identification tag is provided. The transmitting circuit includes a clock circuit for respectively generating a series of clock signals for elements in the identification data transmitting circuit, an selecting circuit having a counter, a random numeral generator and a comparator for providing an enable signal by means of comparing outputs of the counter and the random numeral generator, and a memory device being electrically connected between the clock circuit and the selecting circuit for storing the identification data of radio frequency identification tag and receiving the enable signal of selecting circuit, so as to output the identification data.

### FIELD OF THE INVENTION

The present invention is related to radio frequency identification tags, and more particularly, to a circuit and method for reading multiple radio frequency identification tags.

### BACKGROUND OF THE INVENTION

Radio frequency identification (RFID) system means that after an exciter transmits identification signals by radio and a receiver receives the radio decode identification, the receiver decodes identification tag signals to accomplish personal identification function. This kind of system usually is used in an access control, an inventory-control, or an interactive-toy identification. RFID Tag or transponder ordinarily includes antennas and Integrated Circuits (IC). The inner of the RFID Tag chip stores an identification code, wherein the code can be used for identifying the people or goods with the RFID Tag. According to a RFID system, it usually names the identification terminal as a reader, a card reader, or an interrogator. When a RFID tag enters to a reading zone of a reader, the tag will receive the electromagnetic signals from the reader. The energy of electromagnetic signals will be transmitted to a RFID tag chip via an antenna, and then the operating voltage will be generated for the RFID tag to transmit the RFID code stored therein to the reader. In the whole process, the RFID tag doesn't need any power source such as batteries, so its bulk can be small. This kind of RFID tags without batteries can be called passive tags. The bar codes on commodities may be another kind of passive tags, but its reading method is used optical principles which is different from the radio frequency method in accordance with the present invention. On the contrary, the tags with a power source may be called active tags. Because the passive tags receive energies via electromagnetic signals, their power is small, and they only be used in a small distance. However, the active tag has the power source, so they have more output power. Therefore, they can be used in a long distance.

When RFID tags of RFID systems are close to a reader, the RFID tags get enough power, then they will transmit continuous signals for the reader to recognize. But when more than two RFID tags are close to a reader, a data collision will happen. Then the reader cannot read the signals or makes the wrong decision. In the U.S. Pat. No. 5,883,582 filed Mar. 16, 1999 by John H. Bowers, titled “Anticollision Protocol for Reading Multiple RFID Tags”, it discloses a kind of method for preventing a data collision when multiple RFID tags transmit signals are used the different of intervals in which every RFID tag repeating to transmit signals. The intervals are used the drift of manufacturing tolerances to make the different. This kind of method has a major problem i.e. an uncertain factor of drift, so it can not ensure the interval differences of every RFID tag and it will increase many loads on quality-control and product-testing when mass production.

Because of the technical defects described above, the applicant keeps on carving unflaggingly to develop “radio frequency identification tag circuit and method for reading multiple tags” through wholehearted experience and research.

### SUMMARY OF THE INVENTION

It is another object of the present invention to provide a RFID tag transmitting circuit and method.

It is another object of the present invention to provide a RFID tag circuit and method for reading multiple tags.

It is another object of the present invention to provide a RFID tag circuit and method for preventing a data collision.

According to the present invention, the identification data transmitting circuit includes a clock circuit for respectively generating a series of clock signals for elements in the identification data transmitting circuit, an selecting circuit having a counter, a random numeral generator and a comparator for providing an enable signal by means of comparing outputs of the counter and the random numeral generator, and a memory device electrically connected between the clock circuit and the selecting circuit for storing the identification data of radio frequency identification tag and receiving the enable signal of selecting circuit, so as to output the identification data.

Preferably, the clock circuit includes an oscillator for generating an oscillation signal and a frequency divider for transforming the oscillation signal into the clock signals.

Preferably, the oscillator includes resistors and capacitors.

Preferably, the oscillator is a quartz oscillator.

Preferably, the oscillator generates the oscillation signal by means of trimming a received electromagnetic oscillation signal.

Preferably, the identification data is a code.

Preferably, the selecting circuit providing an enable signal when the outputs are equal.

Preferably, the memory device includes a memory, an address generator and an output logical control circuit.

Preferably, the memory is a non-volatile memory.

Preferably, the address generator generates addresses for the memory, so as to output the identification data stored in the memory in turn.

Preferably, the output logical control circuit transforms the identification data from the memory into a format easy to be transmitted in a radio wave.

Preferably, the identification data of the radio frequency identification tag are stored in the memory.

Preferably, the random numeral generator of the selecting circuit further includes a linear feedback shift register and a combination logical circuit.

According to another aspect of the present invention, an identification data transmitting circuit for controlling a transmission of an identification data in radio frequency identification tag includes a memory device for storing the identification data of the radio frequency identification tag, a counter for outputting a count value, a random numeral generator for outputting a random number, and a comparator electrically connected to the counter and an output terminal of the random numeral generator respectively for comparing the count value of the counter and the random number of the random numeral generator and providing an enable signal.

Preferably, the identification data is a code.

Preferably, the transmitting circuit further includes a clock circuit for generating a clock signal.

Preferably, the comparator provides an enable signal for the memory device in response to the signal and transmits the identification data therein to a signal transmitting device when the count value and the random number are equal, so as to transmit the identification data by radio frequency method.

According to another aspect of the present invention, a method of identification data transmission for transmitting an identification data in a radio frequency identification tag, comprising steps of: providing a series of clock oscillation signals in response to an electromagnetic signal of a reader for the radio frequency identification tag, obtaining a random number, the random number is smaller than a maximum count value, counting in response to the series of oscillation signals obtaining a count value by means of, wherein the count value denotes a specific operating region; and when the count value and the random number in the operation region are equal, outputting the identification data.

Preferably, the identification data is a code.

Preferably, the count value is an integral repeatedly counted from 1 to M.

Preferably, the random number is free of being reset for providing a maximum random effect.

Preferably, the operating region includes an operating period long enough to transmit the identification data more than two times.

The foregoing and other features and advantages of the present invention will be more clearly understood through the following descriptions with reference to the drawings, wherein:

### BRIEF DESCRIPTION OF THE DRAWINGS

FIG. 1 is a schematic view of a reader reading multiple RFID tag signals simultaneously according to the present invention;

FIG. 2 is a schematic view of a RFID tag circuit according to a preferred embodiment of the present invention;

FIGS. 3(a)˜3(b) is a schematic view of the RFID tags transmitting clock of multiple RFID tags according to a preferred embodiment of the present invention;

FIG. 4 is a schematic view of the format 0 and 1 of the outputting signals according to a preferred embodiment of the present invention; and

FIG. 5 is a schematic view of the circuit of the random number generator according to a preferred embodiment of the present invention.

### DETAILED DESCRIPTION OF THE PREFERRED EMBODIMENT

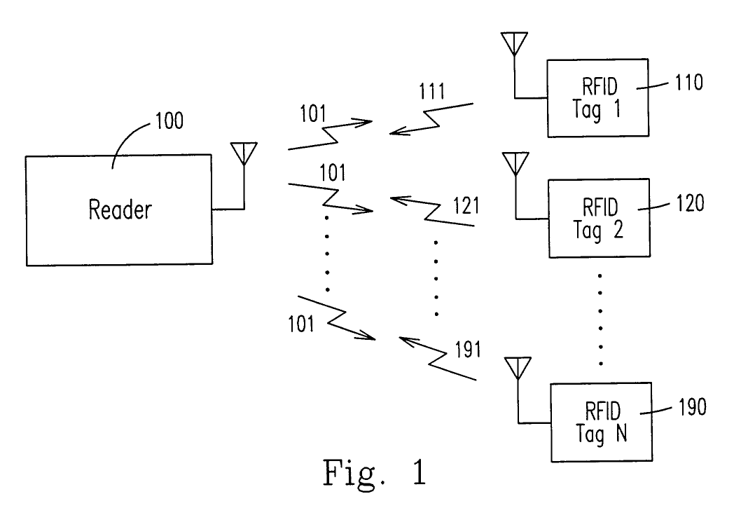

Please refer to FIG. 1. FIG. 1 is a schematic view of a reader reading multiple RFID tags simultaneously. The reader 100 transmits a constant electromagnetic frequency 101. When the RFID tags 110, 120, 190 are close to the reader, they receive the electromagnetic signal 101, get enough power to start working, and then transmit the RFID code of every tag to the reader 100 by radio. If the transmitting method or transmitting time of RFID tags are not special arranged, when a plurality of RFID tags are close to a reader simultaneously, every tag continues transmitting a RFID signal to the reader. When two or more two RFID tags continue transmitting the RFID signals simultaneously, a data collision happens and the reader cannot recognize individual tag correctly. The transmitting time of a RFID tag names as an operation time slot, and the magnitude of the operating time slot can be adjusted by circuit design. In the ordinary design, the operation time slot is about several milliseconds so as to complete RFID two or three transmissions in an operating time slot. Every RFID tag will select one operating time slot to transmit a RFID data in M operating time slots. It will depend on random number value to select an operating time slot. If there are 64 operating time slots (M=64), the probability of two RFID tags transmitting at the same time is 3.1%. But the time of every RFID tag entering into a reading zone usually at least has one to several seconds above, if every operating time slot is 5 milliseconds. Then the total length of 64 operating time slot is only 320 milliseconds, so the REID tag has several times to transmit RFID code. According to the probability theorem, if the probability of random number value is uniform, then the probability is merely about 0.1% when a data collision happens second times. In other words, a collision happens in every thousand times, so two RFID tags will be read by a reader correctly in a reasonable time. And if there are three RFID tags used simultaneously, the probability of a data collision is 4.8%, then the probability of a second collision is 0.23%, so these three RFID tags will be recognized by the reader respectively in a reasonable period.

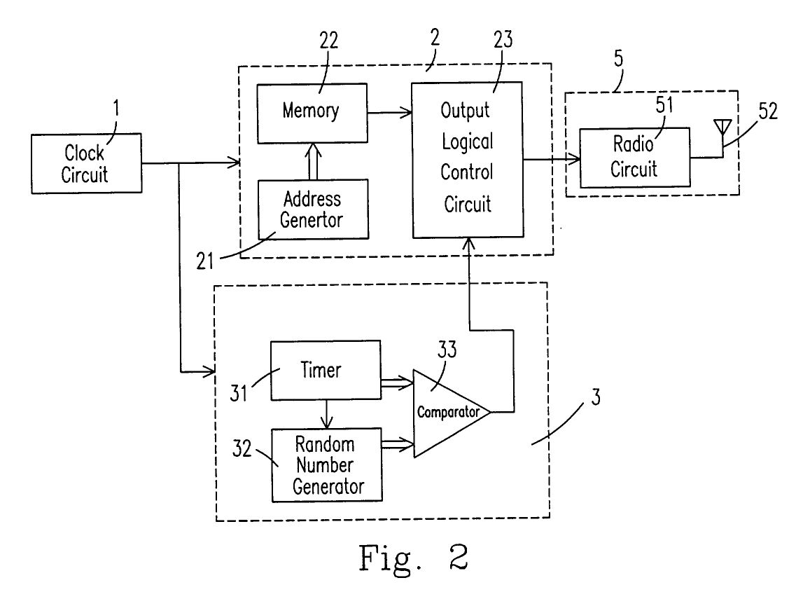

Please refer to FIG. 2. FIG. 2 is a schematic view of an RFID tag transmitting circuit according to the present invention. As shown in FIG. 2, the RFID transmitting circuit electrically connects the clock circuit 1 and the signal transmitting device 5, including: a memory device 2 for storing identification code of RFID tag, a operation time slot circuit 3 having a timer 31 for outputting a count number (first number), a random number generator 32 for outputting a random number (second number), and a comparator 33 having the input port being electrically connected to the input ports of the timer and the random number generator for comparing the first and second number. If the two number values are equal, the comparator provides an enable control signal which enables the output logical control circuit 23, and the identification data of the memory 22 passes through the output logical control circuit 23 to the signal transmitting device 5. Then the identification data is transmitted by RF signals.

The device about the clock circuit 1 usually includes a resistance-capacitance oscillator for providing an oscillating signal, and a frequency divider for outputting the oscillating signal to a clock signal in a lower frequency and a better square waveform. Another device about the clock circuit is to revise the electromagnetic oscillating signal from a reader and provide the clock signal which the RFID transmitting circuit needed. The signal transmitting device 5 is usually composed of RF circuit and antenna.

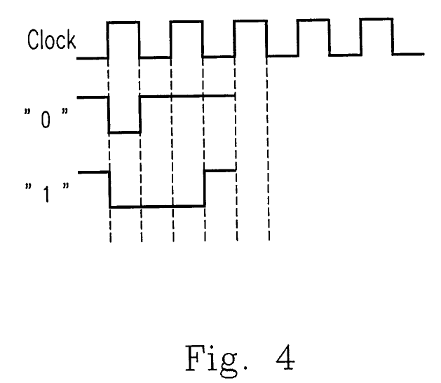

The memory device 2 of the RFID transmitting circuit is composed of an address generator 21, a memory 22, and an output logical control circuit 23. The identification data of the RFID tag is stored in the memory 22. To prevent data loss, the memory 22 is a non-volatile memory, so the data in the memory will not disappear without a power source. Because of transmitting data by a RF method is transmitting data one bit by one bit, so it needs the address generator 21 operation to generate the address of individual bit for transmitting the identification data stored in the memory 22 in turns. Then the output logical circuit 23 converts the output to the format (please refer to FIG. 4) which is easier to transmit by radio and outputs to the signal transmitting device 5.

Accordingly, the operation time slot circuit 3 includes a timer 31, a random number generator 32 and a comparator. The comparator 31 starts to count by a clock signal and counts from 1 to M. When counting to M, the comparator counts again and transmits a trigger signal to the random number generator 32, then the random number generator 32 outputs a random number (the value is from 1 to M) in response to the trigger signal. The comparator 33 electrically connects to the timer 31, the random number generator 32 and the output logical control circuit 23 for comparing the counting number and the random number. If the two numbers are equal, the comparator transmits an enable signal to the output logical control circuit 23 of the memory device 2. Because the input port of the output logical control circuit 23 is coupled to the memory 22 and the output port of the output logical control circuit 23 is coupled to a signal transmitting device 5, the identification data stored in the memory 22 transmit to the signal transmitting device 5 through the output logical control circuit 23 for transforming the format when the output logical control circuit 23 receives the enable signal which is transmitted by the comparator 33. The signal transmitting device 5 is composed of a RF circuit 51 and an antenna. When the signal transmitting device 5 receives the formatted identification data signal, and it transmits the formatted identification data signal to the reader through the RF circuit and the antenna.

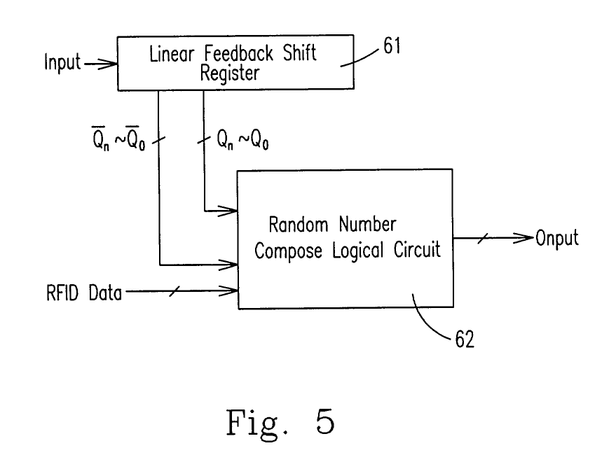

Please refer to FIG. 5. The random number generator 32 basically is used an eight-bit linear feedback shift register 61 as a core. After coupled to a random number compose logical circuit 62, the random number generator can provide several thousands of eight-bit numbers. If we use the specific ID code of every RFID tag to select the bit order of the shift register, the different RFID tags have different random number generating method and solution, so as to reach the requirement that the present invention needed.

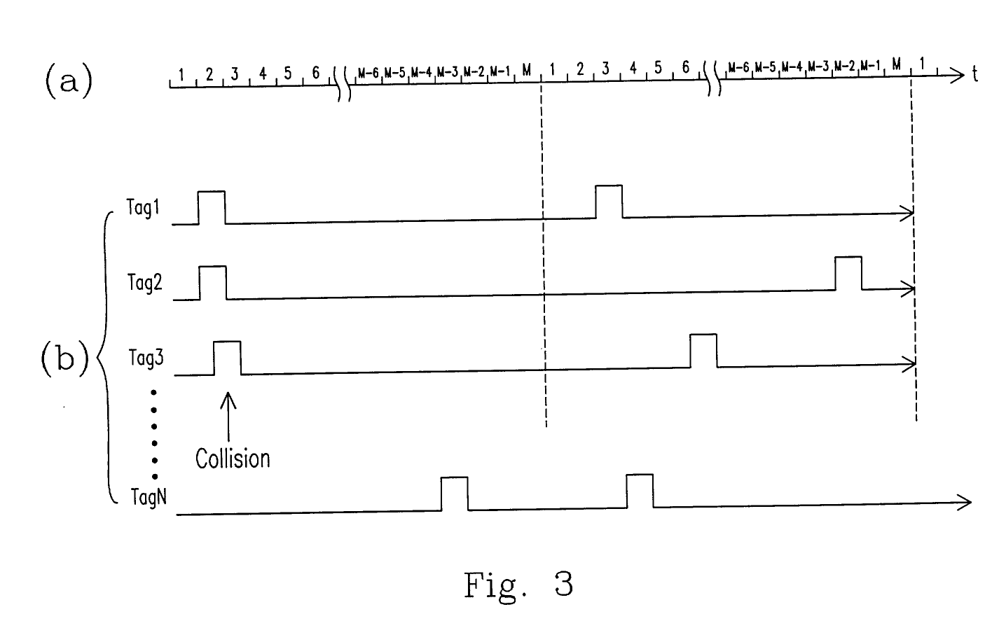

Please refer to FIG. 3(a). FIG. 3(a) shows a schematic view of the RFID tag transmitting operation clock. In FIG. 3(b), there are N RFID tags used simultaneously. Accordingly, when the number of the RFID tags is decreasing, the probability of the data collision is small. That is, the reader easier reads the individual RFID tag correctly in a short time. As FIG. 3(a) shows, there are M operation time slots. The timer 31 of every RFID tag starts to count from 1 to M, and counts again. When recounting, the timer provides a trigger signal to the random number generator 32, so as to provide a random number. The random number generator 32 is response to the trigger signal and generates a random number. The comparator 33 will continue to compare the count number and the previous random number. When the two numbers are equal, the comparator 33 outputs an enable signal to the output logical control circuit 23. Finally, the above method is repeated again until the RFID tag is away from the reading zone of a reader.

Accordingly, the present invention random selects the transmitting period of individual RFID tag, so data collisions are not easily to happen and a reader can read the tags easily. Because the transmitting time is very small, random selecting will stagger the operation time slots of two terms after a data collision happens. Therefore, the probability of re-collision is very small.

While the invention has been described in terms of what is presently considered to be the most practical and preferred embodiments, it is to bee understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An identification data transmitting circuit for controlling a transmission of an identification data in radio frequency identification tag, comprising:
a clock circuit for respectively generating a series of clock signals for elements in said identification data transmitting circuit.
an selecting circuit having a counter, a random numeral generator and a comparator for providing an enable signal by means of comparing outputs of said counter and said random numeral generator; and
a memory device electrically connected between said clock circuit and said selecting circuit for storing said identification data of radio frequency identification tag and receiving said enable signal of selecting circuit, so as to output said identification data.

2. The circuit according to claim 1, wherein said clock circuit comprises an oscillator for generating an oscillation signal and a frequency divider for transforming said oscillation signal into said clock signals.

3. The circuit according to claim 2, wherein said oscillator includes resistors and capacitors.

4. The circuit according to claim 2, wherein said oscillator is a quartz oscillator.

5. The circuit according to claim 2, wherein said oscillator generates said oscillation signal by means of trimming a received electromagnetic oscillation signal.

6. The circuit according to claim 1, wherein said identification data is a code.

7. The circuit according to claim 1, wherein said selecting circuit providing an enable signal when said outputs are equal.

8. The circuit according to claim 1, wherein said memory device comprises a memory, an address generator and an output logical control circuit.

9. The circuit according to claim 8, wherein said memory is a non-volatile memory.

10. The circuit according to claim 8, wherein said address generator generates addresses for said memory, so as to output said identification data stored in said memory in turn.

11. The circuit according to claim 8, wherein said output logical control circuit transforms said identification data from said memory into a format easy to be transmitted in a radio wave.

12. The circuit according to claim 8, wherein said identification data of said radio frequency identification tag are stored in said memory.

13. The circuit according to claim 1, wherein said random numeral generator of said selecting circuit further comprises a linear feedback shift register and a combination logical circuit.

14. An identification data transmitting circuit for controlling a transmission of an identification data in radio frequency identification tag, comprising:
a memory device for storing the identification data of said radio frequency identification tag;
a counter for outputting a count value;
a random numeral generator for outputting a random number; and
a comparator electrically connected to said counter and an output terminal of said random numeral generator respectively for comparing said count value of said counter and said random number of said random numeral generator and providing an enable signal.

15. The circuit according to claim 14, wherein said identification data is a code.

16. The circuit according to claim 14 further comprises a clock circuit for generating a clock signal.

17. The circuit according to claim 14, wherein said comparator provides an enable signal for said memory device in response to said signal and transmits said identification data therein to a signal transmitting device 5 when said count value and said random number are equal, so as to transmit said identification data by radio frequency method.

18. A method of identification data transmission for transmitting an identification data in a radio frequency identification tag, comprising steps of:
(a) providing a series of clock oscillation signals in response to an electromagnetic signal of a reader for said radio frequency identification tag;
(b) obtaining a random number, said random number is smaller than a maximum count value;
(c) counting in response to said series of oscillation signals obtaining a count value by means of, wherein said count value denotes a specific operating region; and
(d) when the count value and said random number in said operation region are equal, outputting said identification data.

19. The circuit according to claim 18, wherein said identification data is a code.

20. The method according to claim 18, wherein said count value is a integral repeatedly counted from 1 to M.

21. The method according to claim 18, wherein said random number is free of being reset for providing a maximum random effect.

22. The method according to claim 18, wherein said operating region includes an operating period long enough to transmit said identification data more than two times.
